(19) United States
(12) Patent Application Publication
(10) Pub. No.: US 2026/0031393 A1
(43) Pub. Date: Jan. 29, 2026

(54) BATTERY ELECTROLYTE

(71) Applicant: FORD GLOBAL TECHNOLOGIES, LLC, Dearborn, MI (US)

(72) Inventors: Sangil HAN, Northville, MI (US); Gunho KWAK, Novi, MI (US); Keonseok OH, Novi, MI (US); Chi PAIK, Grosse Ile, MI (US)

(21) Appl. No.: 18/783,036

(22) Filed: Jul. 24, 2024

(51) Int. Cl. H01M 10/0567; H01M 10/0525; H01M 10/0569

(52) U.S. Cl. CPC H01M 10/0567; H01M 10/0525; H01M 10/0569; H01M 2300/0037

(57) ABSTRACT

In one aspect of the disclosure, an electrode assembly is presented. The electrode assembly includes a positive electrode, a negative electrode, a separator positioned between the positive electrode and the negative electrode, and an electrolyte. The electrolyte includes lithium hexafluorophosphate, lithium bis(fluorosulfonyl)imide, fluoroethylene carbonate, vinylene carbonate, and an additive dissolved in a solvent of ethylene carbonate and ethyl methyl carbonate. This electrolyte saturates the negative electrode, the positive electrode, and the separator. The additive is (S)-N-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide, contributing to improved performance and stability of the electrode assembly.

### TECHNICAL FIELD

This disclosure relates to electrolytes for lithium-ion batteries.

### BACKGROUND

Electrode materials such as lithium and silicon may be used to achieve high energy density and capacity. Silicon, with a high specific capacity may form lithium silicide during charge and discharge cycles. Lithium silicide may irreversibly precipitate on the electrode surface, increasing cell resistance. The expansion and contraction of silicon may also cause cell swelling.

### SUMMARY

In one aspect of the disclosure, an electrode assembly is presented. The electrode assembly includes a positive electrode, a negative electrode, a separator positioned between the positive electrode and the negative electrode, and an electrolyte, including lithium hexafluorophosphate, lithium bis(fluorosulfonyl)imide, fluoroethylene carbonate, vinylene carbonate, and an additive dissolved in a solvent of ethylene carbonate and ethyl methyl carbonate, saturating the negative electrode, the positive electrode, and the separator, wherein the additive is (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide. The electrolyte may include 0.7M of lithium hexafluorophosphate and 0.3M of lithium bis(fluorosulfonyl)imide. The solvent may include ethylene carbonate and ethyl methyl carbonate in a 25/75 volume ratio. The electrolyte may include 1 wt. % fluoroethylene carbonate. The electrolyte may also include 1 wt. % vinylene carbonate. In some configurations, the electrolyte may include 0.3 wt. % of the additive. The multifunctional additive may contain a sulton group and a fluorinated phosphorous group within its chemical structure. The additive may form a lithium-polymer structure through ring closure. In other configurations, a combination of lithium bis(fluorosulfonyl)imide, fluoroethylene carbonate, vinylene carbonate, and the additive may result in reduced resistance and decreased swelling compared to a battery cell without the combination. The positive electrode and negative electrode may have increased swelling suppression under storage at 60°C compared to a battery cell without the electrolyte. In other configurations, the positive electrode and negative electrode may exhibit increased cycle life performance at 45°C for up to 500 cycles compared to a battery cell without the electrolyte.

In another aspect of the disclosure, a method of manufacturing a battery cell is presented. The method includes positioning a separator between a negative electrode and a positive electrode, dissolving 0.7M lithium hexafluorophosphate, 0.3M lithium bis(fluorosulfonyl)imide, 1 wt. % fluoroethylene carbonate, 1 wt. % vinylene carbonate, and 0.3 wt. % of a multifunctional additive in a solvent mixture of ethylene carbonate and ethyl methyl carbonate in a 25/75 volume ratio to form an electrolyte, wherein the multifunctional additive is (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide, and saturating the negative electrode, the positive electrode, and the separator with the electrolyte. The multifunctional additive may contain a sulton group and a fluorinated phosphorous group within its chemical structure. The multifunctional additive may form a lithium-polymer structure through ring closure.

In yet another aspect of the disclosure, an electrolyte for a battery cell is presented. The electrolyte includes 0.7M lithium hexafluorophosphate, 0.3M lithium bis(fluorosulfonyl)imide, 1 wt. % fluoroethylene carbonate, 1 wt. % vinylene carbonate, 0.3 wt. % of a multifunctional additive, and a solvent mixture of ethylene carbonate and ethyl methyl carbonate in a 25/75 volume ratio, wherein the multifunctional additive is (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide. The multifunctional additive may contain a sulton group and a fluorinated phosphorous group within its chemical structure. The multifunctional additive may form a lithium-polymer structure through ring closure. In some configurations, lithium bis(fluorosulfonyl)imide, fluoroethylene carbonate, vinylene carbonate, and the multifunctional additive may result in reduced resistance and decreased swelling in a battery cell with the electrolyte compared to a battery cell without the electrolyte. A battery cell with the electrolyte may have increased swelling suppression under storage at 60°C compared to a battery cell without the electrolyte. A battery cell with the electrolyte may have increased cycle life performance at 45°C for up to 500 cycles compared to a battery cell without the electrolyte.

### BRIEF DESCRIPTION OF THE DRAWINGS

FIG. 1 is a schematic diagram of an additive according to one or more aspects of the disclosure;

FIG. 2 is a schematic diagram of an additive according to one or more aspects of the disclosure;

FIG. 3 is a graph of differential potential against differential voltage of a battery with an electrolyte incorporating the additive in FIG. 2;

FIG. 4 is a linear sweep voltammetry graph of a battery with an electrolyte incorporating the additive in FIG. 2;

FIG. 5 is a table of electrolyte compositions according to one or more aspects of the disclosure;

FIG. 6 is a table of electrolyte compositions and their properties according to one or more aspects of the disclosure;

FIG. 7 is a graph of retention percentage of batteries incorporating electrolytes according to one or more aspects of the disclosure;

FIG. 8 is a graph of direct current internal resistance of batteries incorporating electrolytes according to one or more aspects of the disclosure;

FIG. 9 is a graph of swelling rate percentage of batteries incorporating electrolytes according to one or more aspects of the disclosure; and

FIG. 10 is a schematic diagram of a battery with an electrolyte according to one or more aspects of the disclosure.

### DETAILED DESCRIPTION

As required, detailed embodiments of the claimed subject matter are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments of the claimed subject matter.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when the liquid electrolyte is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

The present disclosure relates to an electrolyte composition for lithium (Li)-ion batteries, designed to increase performance and longevity under various conditions. A specific multifunctional additive (MFA) ((s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide) is identified for inclusion in electrolyte compositions. This MFA incorporates both a sulton group and a fluorinated phosphorous group, and has the potential to form a Li-polymer structure through ring closure. The presented electrolyte includes a combination of 0.7 molar (M) lithium hexafluorophosphate (LiPF₆) as a primary salt, 0.3M lithium bis(fluorosulfonyl)imide (LiFSI) as a subsidiary salt, a solvent mixture of ethylene carbonate/ethyl methyl carbonate (EC/EMC) at a 25/75 vol%, and additives including 1 wt. % fluoroethylene carbonate (FEC), 1 wt. % vinylene carbonate (VC), and the 0.3 wt. % MFA. This formulation demonstrates swelling suppression under high-temperature storage conditions (60 °C) and maintains cycle life performance at elevated temperatures (45 °C) for up to 500 cycles.

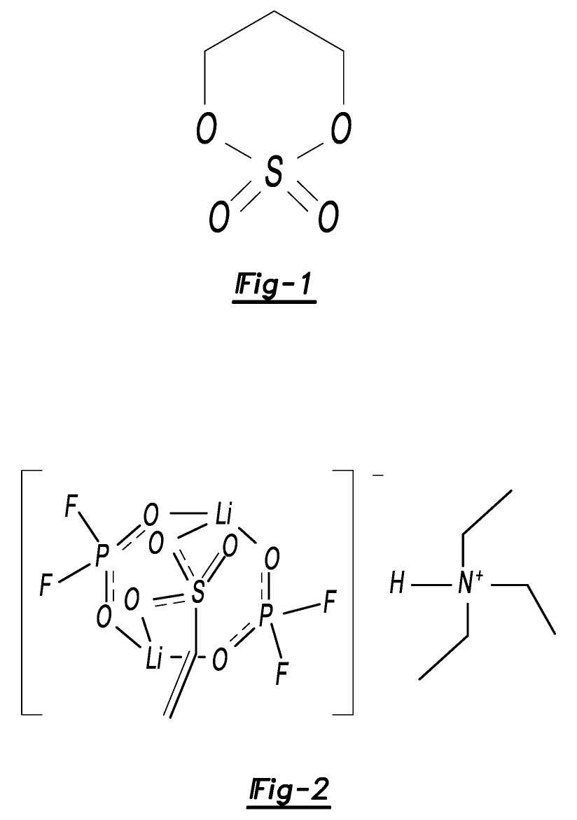

FIG. 1 is a schematic diagram of the chemical structure of an additive 1,3-propanediol cyclic sulfate (PA355). The structure has a six-membered ring forming the core of the molecule. At the top of the ring is a CH₂ group, represented by a simple line forming a point. This connects to two oxygen atoms, one on each side, with “O” symbols. At the bottom of the ring structure is a sulfur atom, with an “S.” This sulfur atom is connected to the rest of the ring by four lines, indicating it forms a sulfate group with double bonds to two oxygen atoms. Cyclic sulfates give the molecule its properties as a sulfate-based additive, which may be beneficial for use in battery electrolytes or other chemical processes.

FIG. 2 is a schematic diagram of the chemical structure of an additive (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide (PA800). The structure is represented as an ionic compound with two distinct parts. On the left side is a complex anion enclosed in square brackets with a negative charge. This anion contains two phosphorus atoms, each bonded to two fluorine atoms and two oxygen atoms. It also includes a sulfur atom bonded to two oxygen atoms, and two Li ions associated with the oxygen atoms. On the right side is a cation, specifically an ethylammonium ion. This cation has a central nitrogen atom with a positive charge, three ethyl groups (CH₂CH₃) attached to the nitrogen, and one hydrogen atom also attached to the nitrogen. This ionic structure gives PA800 its properties, making it useful as an electrolyte additive in battery applications where its complex chemical composition may enhance performance or stability.

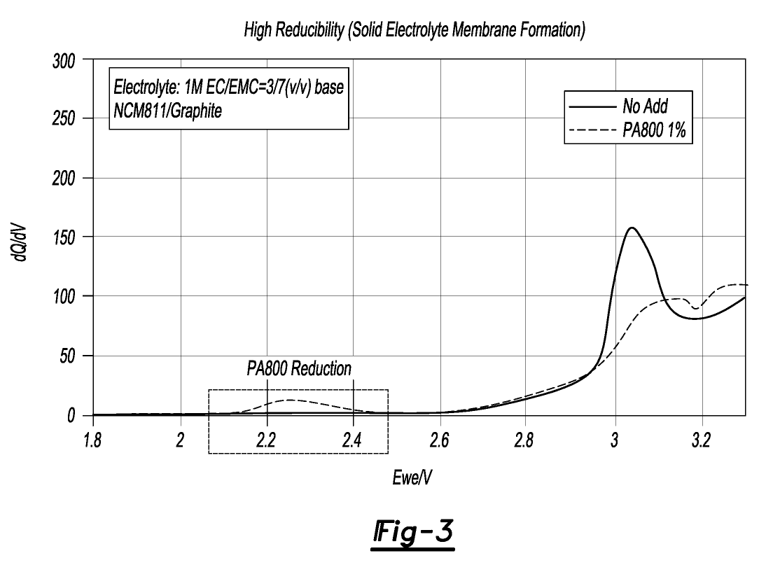

FIG. 3 is a graph of the differential capacity (dQ/dV) against voltage in electronvolt per volt (Ewb/V) of a battery with and without the PA800 additive shown in FIG. 2. FIG. 3 shows the high reducibility and solid electrolyte membrane formation characteristics of PA800. The x-axis represents the voltage ranging from 1.8 to 3.2 volts (V), while the y-axis shows the differential capacity ranging from 0 to 300 microampere-hours per volt (μAh/V). The graph compares a base electrolyte without additives labeled “No add” to the same base electrolyte with 1 wt. % PA800 additive. The base electrolyte composition is 1M EC/EMC in a 3/7 volume ratio (v/v). The battery electrodes are nickel cobalt manganese (NCM) 811 paired with graphite, NCM is a cathode material with a ratio of 80% nickel, 10% cobalt, and 10% manganese. A dotted box highlights the region between approximately 2.2 and 2.4 volts, labeled “PA800 reduction,” where the PA800 additive undergoes reduction, contributing to the formation of a solid electrolyte interface (SEI) layer. The curves show distinct differences in behavior, the “No add” curve exhibits a peak around 3V, followed by a decline, while the PA800 curve shows a more gradual increase, with multiple smaller peaks between 2.8V and 3.2V. This comparison suggests that the addition of PA800 alters the electrochemical behavior of the battery, potentially improving the formation of a stable SEI layer and increasing the overall performance of the battery.

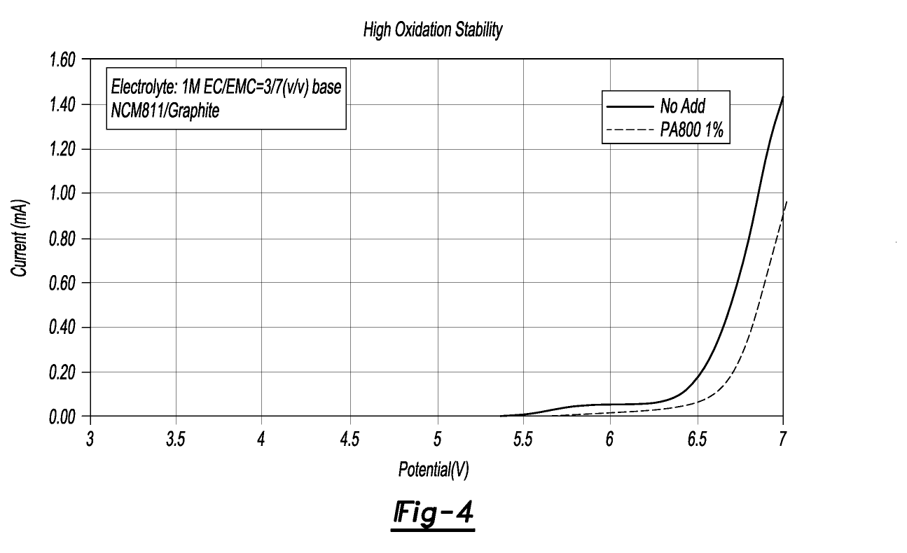

FIG. 4 is a linear sweep voltammetry (LSV) graph demonstrating the high oxidation stability of a battery electrolyte with and without the PA800 additive shown in FIG. 2 The x-axis represents the potential (V) ranging from 3V to 7V while the y-axis shows the current in milliamperes (mA) from 0 to 1.60 The graph compares two electrolyte compositions, a base electrolyte without additives labeled “No add” and the same base electrolyte with 1 wt. % PA800 additive labeled “PA800 1%” The working electrode is platinum (Pt) vs Li/Li⁺, the scan rate is 1 millivolts per second (mV/sec), and the scan range is 3V to 7V. An inset table provides additional data showing that at a current density of 0.1 mA/cm², the “No add” electrolyte reaches this threshold at 5.42V while the PA800 1 wt. % electrolyte reaches it at 5.66V. Both curves remain relatively flat until about 5.5V after which they show an increase in current. The PA800 additive curve demonstrates a higher onset potential for oxidation and a less steep increase in current compared to the base electrolyte indicating improved oxidation stability of the electrolyte with the PA800 additive.

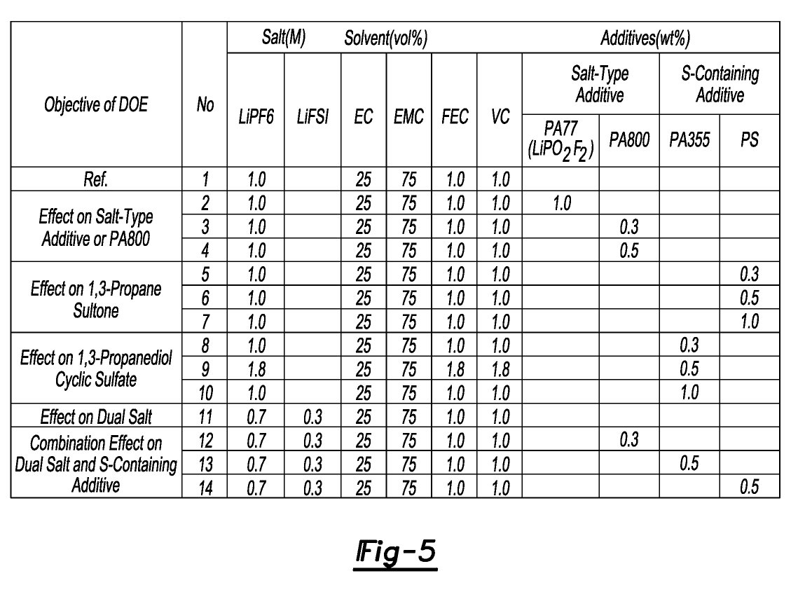

FIG. 5 is a table of electrolyte compositions, showing their various formulations and their effects on battery performance. The reference sample (Ref. No. 1) includes 1.0M LiPF₆, 25% EC, 75% EMC, 1.0 wt. % FEC, and 1.0 wt. % VC. The first set of compositions (Nos. 2-5) explore the effect of salt-type additives and PA800. These compositions maintain the base electrolyte while including different additives: 1.0 wt. % lithium difluorophosphate (LiPO₂F₂ or PA77) in composition No. 2, 0.3 wt. % PA800 in composition No. 3, 0.5 wt. % PA800 in composition No. 4, and 0.3 wt. % PA355 in composition No. 5. This series aims to evaluate the effect of these additives on the electrolyte's performance. The next set of compositions (Nos. 6-7) investigate the effect of 1,3-propane sultone (PS). These compositions incorporate 0.5 wt. % and 1.0 wt. % PS respectively, while keeping other components constant. Experiment Nos. 8-10 focus on the effect of PA355, with 0.3 wt. %, 0.5 wt. %, and 1.0 wt. % respectively. Experiment No. 11 introduces a dual salt system. This composition includes 0.7M LiPF₆ and 0.3M LiFSI, while maintaining the other components. The final set of compositions (Nos. 12-14) build upon this dual salt system, combining 0.7M LiPF₆ and 0.3M LiFSI with 0.3 wt. % and 0.5 wt. % PA800 respectively, while No. 14 adds 0.5 wt. % PS to the dual salt base.

The design of experiments (DOE) specifies that certain compositions showed particularly promising results. Specifically, the formulations with 0.5 wt. % PS (No. 6), 0.5 wt. % PA355 (No. 9), and 0.3 wt. % PA800 (No. 3) demonstrated swelling suppression and reduced direct current internal resistance (DC-IR) under 60 °C storage test conditions. These compositions also exhibited acceptable cycle life performance at 45 °C. Based on these findings, additional experiments (Nos. 11-14) to explore the potential of combining the dual salt system with the most effective additives were conducted.

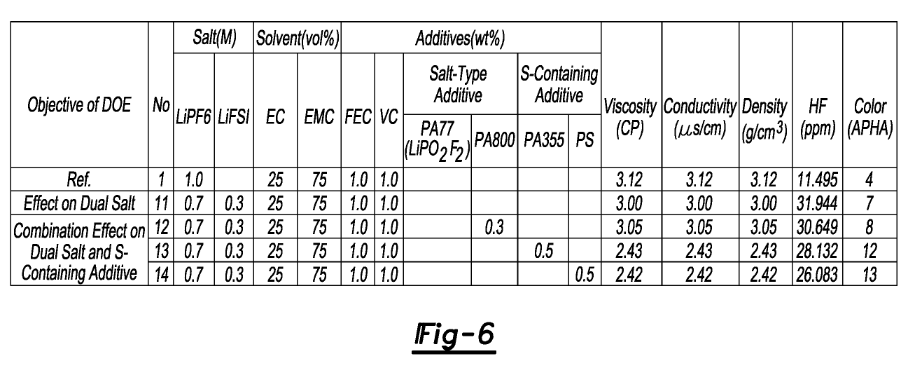

FIG. 6 is a table of electrolyte compositions and their corresponding properties. The reference composition (Ref., No. 1) includes 1.0M LiPF₆ as the salt, with a solvent mixture of 25% EC and 75% EMC by volume. This reference also includes 1.0 wt. % FEC and 1.0 wt. % VC as additives. The properties of this reference electrolyte are listed as 3.12 centipoise (cP) viscosity, 9.241 microsiemens per centimeter (μS/cm) conductivity, 1.1978 grams per cubic centimeter. (g/cm³) density, 11.495 parts per million (ppm) hydrofluoric acid (HF) content, and a color rating of 4 per the American Public Health Association Hazen scale (APHA). The subsequent rows explore the effects of modifying this base composition. Composition No. 11 includes a dual salt system, replacing part of the LiPF₆ with LiFSI. This composition uses 0.7M LiPF₆ and 0.3M LiFSI, maintaining the same solvent and additive ratios as the reference. This change results in a decrease in viscosity to 3.00 cP, a slight increase in conductivity to 9.526 μS/cm, a minor decrease in density to 1.1968 g/cm³, and an increase in HF content to 31.944 ppm. The color rating also increases to 7 APHA.

Composition No. 12 adds 0.3 wt. % PA800 to the dual salt composition, resulting in a slight increase in viscosity to 3.05 cP, a decrease in conductivity to 9.311 μS/cm, a small increase in density to 1.1972 g/cm³, and a notable decrease in HF content to 30.649 ppm. The color rating increases to 8 APHA. Composition No. 13 explores the effect of 0.5% PA355, leading to a significant decrease in viscosity to 2.43 cP, a slight decrease in conductivity to 9.233 μS/cm, a small increase in density to 1.1977 g/cm³, and a decrease in HF content to 28.132 ppm. The color rating increases further to 12 APHA. Composition No. 14 examines the effect of 0.5% PS, resulting in similar properties to the PA355 composition, with a viscosity of 2.42 cP, conductivity of 9.214 μS/cm, density of 1.1979 g/cm³, and HF content of 28.083 ppm. The color rating for this composition is the highest at 13 APHA.

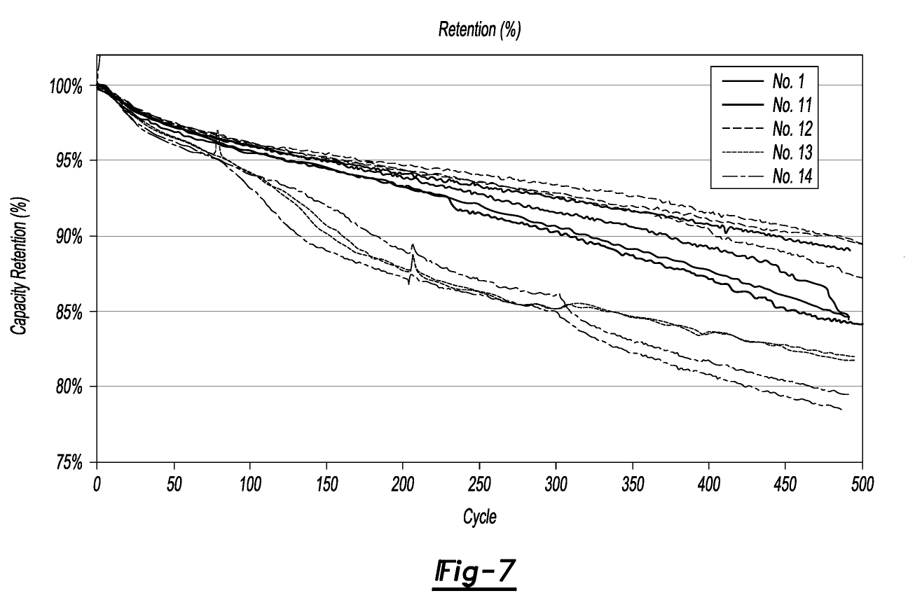

FIG. 7 is a graph of the capacity retention performance of various electrolyte compositions over 500 charge-discharge cycles. The graph shows retention percentage on the y-axis, ranging from 75% to 100%, plotted against the number of cycles on the x-axis, from 0 to 500. A nickel/graphite pouch cell was used as the test condition, with charging at 1 charge/discharge rate (C) ampere-hour (Ah) to a 4.2V cut-off (0.02C) and discharging at 1C (Ah) to 2.7V. The graph compares five different electrolyte compositions, labeled as No.1, No.11, No.12, No.13, and No.14, corresponding to the compositions specified in FIG. 6.

The reference composition, No.1, has a moderate rate of capacity loss, concluding at approximately 85% retention after 500 cycles. Composition No.11, representing the dual salt system, performs slightly worse than the reference, ending at around 84% retention. Composition No.12, which includes the dual salt system and PA800, has the best performance. It maintains the highest capacity retention throughout the test, concluding at approximately 90% after 500 cycles. In contrast, composition No.13, with the dual salt system and PA355 has initial rapid capacity loss up to about 150 cycles before stabilizing, ultimately ending at around 82% retention. Composition No. 14, which incorporates the dual salt system and PS exhibits the poorest performance with the steepest initial decline and the lowest final retention of about 79%. This illustrates that the addition of PA800 to the dual salt system (No.12) increases capacity retention over extended cycling. Conversely, the other additives (PA355 and PS) do not increase performance compared to the reference or dual salt system alone.

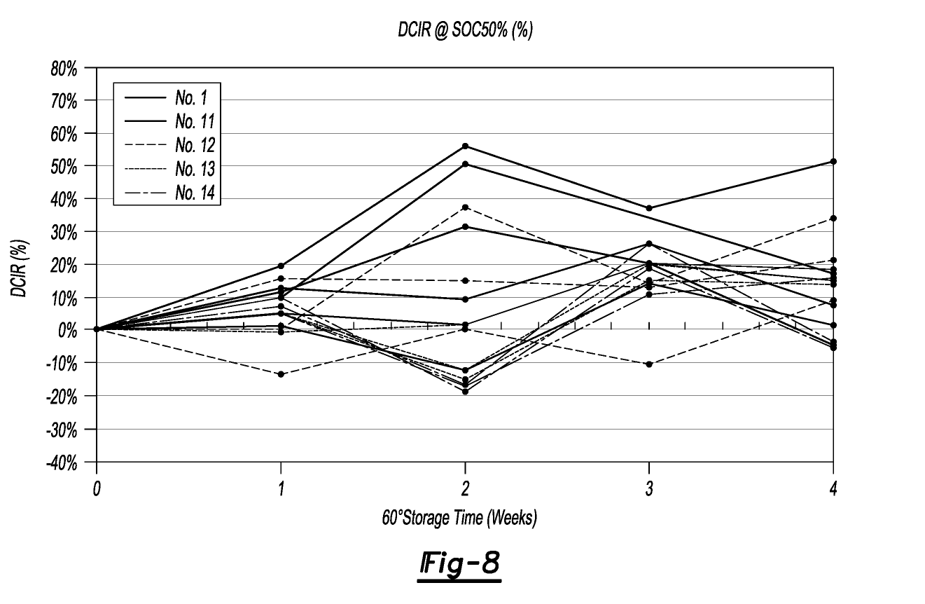

FIG. 8 is a graph of the DC-IR at 50% State of Charge (SOC) for the electrolyte compositions over a 4-week storage period at 60 °C. The graph shows the DC-IR percentage change on the y-axis, ranging from -40% to 80%, plotted against the storage time in weeks on the x-axis, from 0 to 4 weeks. The test conditions include a nickel/graphite pouch cell. The DC-IR check was conducted at SOC 50% with varying C-rates (0.5C/1.0C/2.0C/2.5C) for 10 seconds. The graph compares the five different electrolyte compositions, No. 1, No. 11, No. 12, No. 13, and No. 14. All compositions start at 0% DC-IR change at week 0, but they exhibit different behaviors over the 4-week storage period. The reference composition, No.1, shows a relatively stable performance with minor fluctuations, ending at a slightly negative DC-IR change after 4 weeks. Composition No. 11, representing the dual salt system, demonstrates the most volatile behavior, with large positive spikes in DC-IR at weeks 2 and 4, indicating increases in internal resistance.

Composition No.12, which includes the dual salt system and PA800, displays a more stable performance compared to No. 11, with smaller fluctuations and a moderate increase in DC-IR by week 4. Compositions No. 13 and No. 14, featuring the dual salt system with PA355 and PS respectively, show similar trends to each other. They both exhibit an initial decrease in DC-IR followed by an increase, with No. 13 ending at a slightly higher DC-IR than No.14 after 4 weeks. Composition No. 12 appears to offer a good balance, showing fewer fluctuations in DC-IR compared to the other dual salt compositions. This suggests that the addition of PA800 to the dual salt system may help stabilize the internal resistance of the battery during extended high-temperature storage.

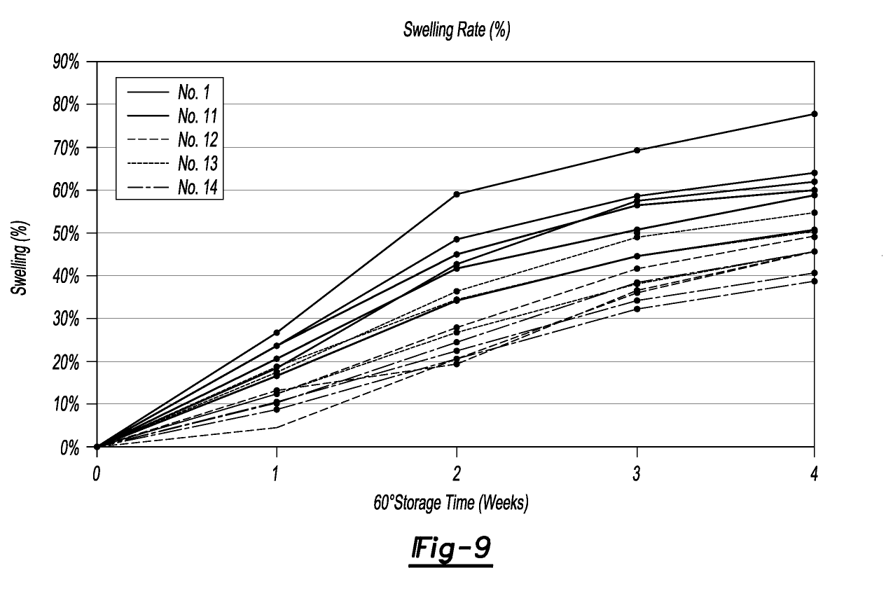

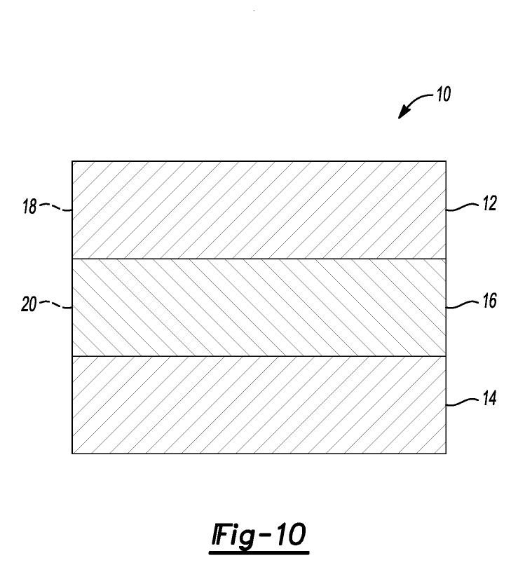

FIG. 9 is a graph of the swelling rate of nickel/graphite pouch battery cells with various electrolyte compositions over a 4-week storage period at 60 °C. The graph shows the swelling rate percentage on the y-axis, ranging from 0% to 90%, plotted against the storage time in weeks on the x-axis, from 0 to 4 weeks. The graph compares the five different electrolyte compositions, labeled as No. 1, No. 11, No. 12, No. 13, and No. 14. All compositions start at 0% swelling at week 0, but they exhibit different swelling behaviors over the 4-week storage period. The reference composition, No. 1, shows the highest swelling rate, reaching approximately 78% by the end of week 4. This indicates that the reference electrolyte provides the least protection against cell swelling under high-temperature storage conditions. Composition No. 11, representing the dual salt system, demonstrates improved swelling resistance compared to the reference, with a final swelling rate of about 62% after 4 weeks. This suggests that the dual salt system alone offers some benefit in reducing cell swelling. Composition No. 12, which includes the dual salt system and PA800, displays the best performance in terms of swelling resistance. It shows the lowest swelling rate throughout the test period, reaching only about 45% swelling by week 4. This improvement over both the reference and the dual salt system alone indicates that the addition of PA800 plays a role in mitigating cell swelling under high-temperature conditions. Compositions No. 13 and No. 14, with the dual salt system with PA355 and PS respectively, show intermediate performance. They both exhibit lower swelling rates than the reference and the dual salt system alone, but higher rates than the PA800 composition. No. 13 ends with a swelling rate of approximately 53%, while No. 14 shows slightly better performance with a final swelling rate of about 50%.

FIG. 10 shows a battery cell 10 with a positive electrode 12, a negative electrode 14, and a separator 16 positioned between the positive electrode 12 and the negative electrode 14. The positive electrode 12 contains a positive active material 18 that forms a layer of the positive electrode 12. The battery cell 10 contains a liquid electrolyte 20. The liquid electrolyte 20 permeates the surface of the positive active material layer and includes 0.7M LiPF₆, 0.3M LiFSI, 1 wt. % FEC, 1 wt. % VC, and 0.3 wt. % of MFA dissolved in a solvent of EC and EMC in a 25/75 volume ratio. This specific composition of the liquid electrolyte 20 is configured to suppress electrochemical oxidation of the positive active material layer 18 during electrochemical cycling. The MFA in the liquid electrolyte 20 is (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide. This additive contains a sulton group and a fluorinated phosphorous group within its chemical structure and is capable of forming a Li-polymer structure through ring closure. The liquid electrolyte 20 saturates the positive electrode 12, the negative electrode 14, and the separator 16 such that the combination of LiFSI, FEC, VC, and the MFA results in reduced resistance and decreased swelling compared to an otherwise same battery cell without this combination. Additionally, the battery cell 10 with this electrolyte composition has increased swelling suppression under storage at 60 °C and increased cycle life performance at 45 °C for up to 500 cycles compared to an otherwise same battery cell without this electrolyte.

In another embodiment, the liquid electrolyte 20 includes the same composition as described above, which saturates the positive electrode 12 and the negative electrode 14. The MFA may interact with the other components to form stable interfaces on the electrode surfaces, thereby reducing impedance and improving cycle life. The solvent mixture of EC and EMC in a 25/75 volume ratio provides a balance between high ionic conductivity and stability, increasing performance of the battery cell 10 and cycle life. The positive active material layer 18 may be composed of a suitable Li-containing compound, which offers high capacity and thermal stability, contributing to the overall performance and stability of the battery cell 10. The battery cell 10 is configured to retain its capacity over a prolonged period, with improved performance characteristics due to the electrolyte composition, including the MFA that forms a Li-polymer structure through ring closure.

While representative embodiments are described above, it is not intended that these embodiments describe all possible forms of the invention. The words used in the specification are words of description rather than limitation, and it is understood that various changes may be made without departing from the claimed subject matter. Additionally, the features of various implementing embodiments may be combined to form further embodiments within the scope of the claimed subject matter that are not explicitly described or illustrated.

What is claimed is:

1. An electrode assembly comprising:
a positive electrode;
a negative electrode;
a separator positioned between the positive electrode and the negative electrode; and
an electrolyte, including lithium hexafluorophosphate, lithium bis(fluorosulfonyl)imide, fluoroethylene carbonate, vinylene carbonate, and an additive dissolved in a solvent of ethylene carbonate and ethyl methyl carbonate, saturating the negative electrode, the positive electrode, and the separator, wherein the additive is (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide.

2. The electrode assembly of claim 1, wherein the electrolyte includes 0.7M of lithium hexafluorophosphate and 0.3M of lithium bis(fluorosulfonyl)imide.

3. The electrode assembly of claim 1, wherein the solvent includes ethylene carbonate and ethyl methyl carbonate in a 25/75 volume ratio.

4. The electrode assembly of claim 1, wherein the electrolyte includes 1 wt. % fluoroethylene carbonate.

5. The electrode assembly of claim 1, wherein the electrolyte includes 1 wt. % vinylene carbonate.

6. The electrode assembly of claim 1, wherein the electrolyte includes 0.3 wt. % of the additive.

7. The electrode assembly of claim 1, wherein the additive contains a sulton group and a fluorinated phosphorous group within its chemical structure.

8. The electrode assembly of claim 1, wherein the additive forms a lithium-polymer structure through ring closure.

9. The electrode assembly of claim 1, wherein a combination of the lithium bis(fluorosulfonyl)imide, fluoroethylene carbonate, vinylene carbonate, and the additive result in reduced resistance and decreased swelling compared to an otherwise same battery cell without the combination.

10. The electrode assembly of claim 1, wherein the positive electrode and negative electrode have increased swelling suppression under storage at 60 °C compared to an otherwise same battery cell without the electrolyte.

11. The electrode assembly of claim 1, wherein the positive electrode and negative electrode exhibit increased cycle life performance at 45°C for up to 500 cycles compared to an otherwise same battery cell without the electrolyte.

12. A method of manufacturing a battery cell comprising:
positioning a separator between a negative electrode and a positive electrode;
dissolving 0.7M lithium hexafluorophosphate, 0.3M lithium bis(fluorosulfonyl)imide, 1 wt. % fluoroethylene carbonate, 1 wt. % vinylene carbonate, and 0.3 wt. % of a multifunctional additive in a solvent mixture of ethylene carbonate and ethyl methyl carbonate in a 25/75 volume ratio to form an electrolyte, wherein the multifunctional additive is (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide; and
saturating the negative electrode, the positive electrode, and the separator with the electrolyte.

13. The method of claim 12, wherein the multifunctional additive contains a sulton group and a fluorinated phosphorous group within its chemical structure.

14. The method of claim 12, wherein the multifunctional additive forms a lithium-polymer structure through ring closure.

15. An electrolyte for a battery cell comprising:
0.7M lithium hexafluorophosphate;
0.3M lithium bis(fluorosulfonyl)imide; 1 wt. % fluoroethylene carbonate;
1 wt. % vinylene carbonate;
0.3 wt. % of a multifunctional additive, wherein the multifunctional additive is (s)-n-(1-(2-((4-(3-(trifluoromethyl)phenyl)piperazin-1-yl)methyl)pyrrolidin-1-yl)-3,3-dimethyl-1-oxobutan-2-yl)-3-methyl-2-(2-oxo-1,3-diazaspiro[4.5]decan-1-yl)butanamide; and
a solvent mixture of ethylene carbonate and ethyl methyl carbonate in a 25/75 volume ratio.

16. The electrolyte of claim 15, wherein the multifunctional additive contains a sulton group and a fluorinated phosphorous group within its chemical structure.

17. The electrolyte of claim 15, wherein the multifunctional additive is configured to form a lithium-polymer structure through ring closure.

18. The electrolyte of claim 15, wherein lithium bis(fluorosulfonyl)imide, fluoroethylene carbonate, vinylene carbonate, and the multifunctional additive result in reduced resistance and decreased swelling in a battery cell with the electrolyte compared to an otherwise same battery cell without the electrolyte.

19. The electrolyte of claim 15, wherein a battery cell with the electrolyte has increased swelling suppression under storage at 60 °C compared to an otherwise same battery cell without the electrolyte.

20. The electrolyte of claim 15, wherein a battery cell with the electrolyte has increased cycle life performance at 45 °C for up to 500 cycles compared to an otherwise same battery cell without the electrolyte.
